(19) United States
(12) Patent Application Publication
(10) Pub. No.: US 2026/0251548 A1
(43) Pub. Date: Aug. 27, 2026

(54) RESPIRATOR FIT TESTING PARTICLE GENERATION MANAGEMENT

(71) Applicant: OHD, LLLP, Birmingham, AL (US)

(72) Inventors: Shawn Dylan Staack, Arroyo Grande, CA (US); Luther Allen, Birmingham, AL (US)

(73) Assignee: OHD, LLLP, Birmingham, AL (US)

(21) Appl. No.: 19/548,395

(22) Filed: Feb. 24, 2026

Related U.S. Application Data
(60) Provisional application No. 63/762,300, filed on Feb. 24, 2025.

(51) Int. Cl. G01N 15/06; A62B 27/00

(52) U.S. Cl. CPC G01N 15/06; A62B 27/00

(57) ABSTRACT

A method, system, and computer program product for managing particle concentrations without human intervention before, during, and after a respirator fit test. One method includes controlling power to a particle generator to establish a target particle concentration in a breathing zone of a respirator fit test subject, collecting particle concentration data, analyzing the particle concentration data, and controlling, in real time without need for human intervention, power to the particle generator to maintain the target particle concentration.

### CROSS-REFERENCE TO RELATED APPLICATIONS

This application claims the priority to U.S. Provisional Patent Application Serial No. 63/762,300 filed February 24, 2025, the contents of which are incorporated herein in their entirety.

### FIELD OF THE INVENTION

This disclosure generally relates to the field of fit testing for respirators, and more particularly, methods and systems of controlling particle concentration during respirator fit testing.

### BACKGROUND

The use of respirators is required by several national and international standards, including the Occupational Safety and Health Administration (OSHA) in the United States when hazardous substances in the air cannot be controlled to an acceptable level for the health of employees. As a result, millions of individuals who may encounter inhalation hazards on the job rely on respirators.

According to OSHA, to ensure a respirator provides an appropriate level of protection, it is necessary that employers develop and maintain a respiratory protection program, of which respirator fit testing is a core concept. A respirator fit test evaluates the fit of a respirator to a wearer.

Typical quantitative fit tests, such as those employing condensation nuclei counting (CNC), utilize airborne particles to measure respirator leakage. For example, particle concentrations measured within a respirator are commonly compared against reference aerosols generated by a particle generator.

### BRIEF SUMMARY

The present disclosure provides improved particle generation management of particle concentrations before, during, and/or after a respirator fit test.

The present disclosure provides methods, systems, and computer program products for managing particle concentrations during respirator fit testing.

The present disclosure includes a computer-implemented and software-controlled method to manage particle concentrations before, during, and after a respirator fit test, the method including: control power to a particle generator to establish a target particle concentration in a breathing zone of a respirator fit test subject, wherein the breathing zone is within a respirator fit test environment, wherein a particle generator emits at least one particle, and wherein the particle generator is communicatively coupled with a respirator fit testing device; collect particle concentration data, wherein the particle concentration data comprises a particle concentration measured in the respirator fit test environment; analyze the particle concentration data, comprising comparing the particle concentration data to the target particle concentration; and control, in real time without need for human intervention, power to the particle generator to maintain the target particle concentration.

The present disclosure includes a computer-implemented and software-controlled method to manage particle concentrations before, during, and after a respirator fit test, the method including: control power to a particle generator to establish a target particle concentration in a breathing zone of a respirator fit test subject, wherein the breathing zone is within a respirator fit test environment, wherein a particle generator emits at least one particle, and wherein the particle generator is in electrical communication with a respirator fit testing device; collect particle concentration data, wherein the particle concentration data comprises a particle concentration measured in the respirator fit test environment; analyze the particle concentration data, comprising comparing the particle concentration data to the target particle concentration; and emit at least one particle from a particle generator into the breathing zone according to a protocol comprisingat least one interval, wherein power to the particle generator is controlled during the at least one interval, wherein the at least one interval maintains the target particle concentration during a respirator fit test in real time, without the need for human intervention.

### DESCRIPTION OF THE DRAWINGS

It is to be understood that both the foregoing summary and the following drawings and detailed description may be exemplary and may not be restrictive of the aspects of the present disclosure as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The present disclosure may be better understood by reference to the accompanying drawing sheets, in which:

FIG. 1 includes a flow chart of a method for managing particle concentrations before, during, and after a respirator fit test, in accordance with certain aspects of the presently disclosed invention.

FIG. 2 includes a block diagram of a system for managing particle concentrations before, during, and after a respirator fit test, in accordance with certain aspects of the presently disclosed invention.

### DETAILED DESCRIPTION

This disclosure generally describes methods, systems, and computer program products to manage particle concentrations before, during, and after a respirator fit test.

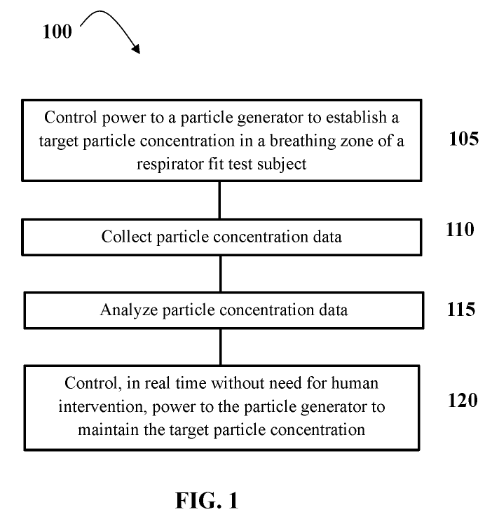

The present disclosure provides a computer-implemented and software-controlled method 100 (FIG. 1) to automatically manage particle concentrations before, during, and after a respirator fit test. The method 100 may include controlling power to a particle generator to establish a target particle concentration in a breathing zone of a respirator fit test subject 105. Controlling power to the particle generator includes supplying power to the particle generator, causing the particle generator to emit at least one particle in the breathing zone. Controlling power to the particle generator includes supplying, increasing, or decreasing power to the particle generator until a target particle concentration (e.g., baseline particle concentration) is established or maintained.

The target particle concentration may be any particle concentration or particle concentration range necessary to successfully conduct a respirator fit test. The target particle concentration may be pre-determined depending on the type of respirator, type of respirator fit test, or the selected codes or regulations, e.g., OSHA standards. The target particle concentration may be selected by a user prior to starting the respirator fit test. The target particle concentration may change before, during, or after the respirator fit test. The target particle concentration may be a range of concentrations, including a minimum target particle concentration and a maximum target particle concentration.

The methods and systems of the present disclosure may control power to the particle generator by increasing power to a power level greater than 0% power or decreasing power to the particle generator to a power level less than 100% power. Thus, the present disclosure allows for variable power output and for increasing or decreasing the power to correspondingly increase or decrease the particle generation and particle concentration. Moreover, the methods and systems of the present disclosure may control power to the particle generator by entirely turning off (e.g., 0% power) or turning on (e.g., 100% power) power to the particle generator. Controlling power to the particle generator may further include pulsatile particle generation, wherein power may be supplied to the particle generator in pulses so as to reach and/or maintain the target particle concentration. Controlling power to the particle generator may further include any other methods known in the art of increasing or decreasing particle output from the particle generator, including, but not limited to, causing an input in one or more components of a particle generator other than increasing or decreasing the power to the particle generator, including, but not limited to, opening or closing a valve.

The method 100 may further include positioning a particle generator in a sufficient position so as to allow the particle generator to emit at least one particle into the breathing zone. As a non-limiting example, the particle generator may be positioned facing the breathing zone of a fit test subject. According to OSHA, a breathing zone is a 10-inch radius around a respirator wearer’s nose and mouth. The present disclosure may manage particle concentrations within a breathing zone that is up to a 48-inch radius around the respirator wearer’s nose and mouth, including, but not limited to, a breathing zone of 10 inches to 48 inches. Proper positioning of the particle generator creates an ideal fit test environment close to or near the breathing zone.

Conventional methods and particle generators known in the art do not direct particles into the breathing zone of the fit test subject, but rather they generally emit particles into the test environment room or open space. As a result, conventional methods and particle generators may be required to be performed or used in a small room in an attempt to create a uniform test environment across the room. However, factors including, but not limited to, air flow, room size, temperature, and pre-existing room particles may interfere with the conventional methods and particle generators, especially when a fit test subject or fit test proctor is burdened with the responsibility of attempting to monitor and control the particle concentration in the test environment.

The method 100 of the present disclosure allows a test environment to be created in larger rooms and open spaces by creating a test environment in the breathing zone of the fit test subject. As a result, the method 100 is able to manage particle concentrations during a respirator fit test conducted in any size room and/or any open space. The method 100 of the present disclosure is influenced less by one or more of the factors discussed above compared to conventional methods and particle generators. Unlike conventional methods, the method 100 of the present disclosure may not be dependent upon the particle concentration of the entire room or open space.

As used herein, a “respirator fit test” includes any qualitative or quantitative respirator fit testing method wherein particle concentration is measured and/or controlled, including but not limited to, Condensation Nuclei Counting (CNC), aerosol particulate counting (APC) or any similar method thereof. As used herein, “particle” refers to any suspended or aerosolized matter. “Respirator fit test” or “respirator fit testing” also refers to any qualitative or quantitative respirator fit test or fit testing method approved or accepted by a regulatory entity or agency, including, but not limited to, OSHA, Centers for Disease Control and Prevention (CDC), International Organization for Standardization (ISO), National Institute for Occupational Safety and Health (NIOSH), and the European Medicines Agency (EMA). As used herein, “respirator fit test” may also refer to daily verification or validation activities for a respirator fit testing device, wherein one or more steps may be executed by a respirator fit testing device. As a non-limiting example, daily verification steps may include verifying the particle generator is supplied power, verifying communication is maintained between the particle generator and respirator fit testing device, and/or verifying particle generation is controlled.

A respirator fit test includes a fit testing device. As used herein, a “fit testing device” refers to any device capable of performing a respirator fit test. The fit testing device may be in communication with the particle generator of the present disclosure. As used herein, “communication” may refer to a direct electrical connection between a fit test device and a particle generator, such as a wired connection, and may also refer to non-wired connections, such as Bluetooth, Z-wave, Wireless USB, and ZigBee. A wired connection may include a powered connection for transferring power or a data connection for transferring data between the particle generator and the fit testing device. The wired connection may include both a powered connection and a data connection. As a non-limiting example, the communication may include a power cable from the particle generator to the fit test device, i.e., direct electrical communication. In one aspect, the power cable may include a two-conductor cable having a first end compatible with the fit test device and a second end compatible with the particle generator. The particle generator may be at least partially within the housing of the fit testing device or may be in communication with the fit testing device.

Unlike prior art devices, methods, and systems wherein the particle generator is a separate device that is not connected to or controlled by the fit testing device, the methods and systems of the present disclosure improve upon the prior art by providing a particle generator that is controlled by and connected to the fit testing device so as to allow the methods and systems of the present disclosure to improve upon respirator fit testing as described herein. Thus, prior art devices, methods, and systems function independently without regard to particle concentration, the respirator fit test, and/or the environment. The fit test device may communicate with the particle generator via a direct electrical connection, or across a personal area network (PAN) such as via a Bluetooth connection wherein a direct electrical connection is not required. Prior art systems do not provide such communication, or only provide communication via the internet, which can be intermittent, absent, or require connection approvals that may be difficult or impossible to attain. Moreover, because the prior art systems fail to provide communication, i.e., wired or wireless connection, between the fit test device and the particle generator, they require human intervention to turn on/off the particle generator, risking particle concentrations within the fit test environment that are either too low or too high, leading to false pass states or failed tests, or possible clogging of the particle generator, respectively. Furthermore, prior art devices and methods are incapable of properly controlling power to the particle generator to establish or maintain a target particle concentration as described herein. The methods and systems of the present disclosure are not limited to a particular fit testing device, respirator fit test, respirator, and/or particle generator.

The method 100 may include collecting particle concentration data 110 (FIG. 1). As used herein, “particle concentration data” refers to a particle concentration measured in the fit test environment, including inside or outside the breathing zone. Accordingly, the method 100 may collect particle concentration data in the fit test environment and/or the breathing zone. Particle concentration data may be collected by any device or component capable of measuring particle concentration data, including, but not limited to, condensation nucleic counters, optical particle counters, laser photometry, light scatter technology, and/or any other sensory technology known in the art.

The method 100 may include analyzing the particle concentration data 115. Analyzing the particle concentration data 115 may include comparing the particle concentration data to the target particle concentration.

After analyzing the particle concentration data 115, the method 100 may control, in real time without need for human intervention, power to the particle generator to maintain the target particle concentration 120 as described herein. The methods and systems of the present disclosure do not require human intervention to control the power to the particle generator, unlike the prior art. This improves upon the prior art, as a human is unable to appropriately measure and control power to the particle generator so as to establish and/or maintain the target particle concentration before, during, and/or after the respirator fit test. Controlling power to the particle generator is described in detail herein.

The methods 100 may establish and/or maintain the target particle concentration in the fit test environment before, during, and/or after the respirator fit test by controlling power to the particle generator. The target particle concentration may depend on the type or brand of respirator to be tested. Furthermore, as used herein, a target particle concentration may include any particle concentration or particle concentration range necessary to properly conduct a respirator fit test as understood by a person of ordinary skill in the art. As a non-limiting example, the target particle concentration may range from 30 particles per cubic centimeter to 100,000 particles per cubic centimeter. The minimum and maximum particle concentrations required for a respirator fit test may depend on the type or brand of respirator to be tested. The target particle concentration or the minimum and maximum particle concentrations may depend on the applicable codes or regulations necessary to satisfy with the respirator fit test. As a non-limiting example, the allowable particle concentration for N95 respirators may range from 30 particles/cc to 30,000 particles/cc, and the allowable particle concentration for total particulate respirators may range from 1,000 particles/cc to 30,000 particles/cc. Conventional methods and particle generators known in the art are typically plugged into a power source and operated continuously, which may flood the environment with particles, result in instrumentation failure, and/or not allow for a target particle concentration to be established or maintained. Other allowable particle concentrations below 1,000 particles/cc and above 100,000 particles/cc are possible and within the scope of the present disclosure. A POSITA may readily determine the target particle concentration based on the type of respirator, the respirator fit test, or any applicable codes or regulations. Unlike conventional methods and particle generators, the method 100 of the present disclosure may cycle power as necessary to manage the target particle concentration in the breathing zone. Unlike the methods 100 disclosed herein, conventional methods and particle generators require a human operator to cycle the power in an attempt to manage or control particle concentration in the fit test environment.

The methods 100 may analyze the data in real time to determine whether the power to the particle generator must be controlled. After analyzing the particle concentration data 115, the methods 100 may control the power to the particle generator in real time, without the need for human intervention. As a non-limiting example, if the particle concentration data is analyzed to be above the target particle concentration, the methods 100 may, in real time, control power, as defined herein, to the particle generator so as to decrease the particle concentration to the target particle concentration. As a non-limiting example, if the particle concentration data is analyzed to be below the target particle concentration, the methods 100 may, in real time, control power, as defined herein, to the particle generator so as to increase the particle concentration to the target particle concentration. As a non-limiting example, the methods of the present disclosure may supply pulses of power to the particle generator so as to maintain the target particle concentration. Thus, the methods may be performed without human-assisted input.

Once a fit test subject, a fit test proctor, or a system for respirator fit testing has initiated a respirator fit test, the methods of the present disclosure may include automatically controlling power to the particle generator to establish or maintain the target particle concentration without a need for human input. A “system for respirator fit testing” may include systems and methods of performing a respirator fit test utilizing a virtual operator, as described in U.S. Patent No. 12,023,529, entitled “VIRTUAL OPERATOR FOR RESPIRATOR FIT TESTING”, which is incorporated by reference herein in its entirety. As used herein, a “proctor” includes an individual that administers and/or is qualified to administer a respirator fit test.

The method 100 may emit at least one particle from a particle generator into the breathing zone according to a protocol. The protocol includes at least one interval wherein the method controls power to the particle generator. Supplying power to the particle generator causes the particle generator to emit particles, thus increasing particle concentration in the breathing zone. Increasing power to the particle generator causes the particle generator to emit more particles, thus increasing particle concentration in the breathing zone. Shutting off, stopping, or cutting off power to the particle generator causes the particle generator to cease emitting particles, thus maintaining or decreasing particle concentration in the breathing zone as the particles in the breathing zone may dissipate from the breathing zone into the open space or room. Decreasing power to the particle generator causes the particle generator to emit less particles, thus maintaining or decreasing particle concentration in the breathing zone. The protocol may be pre-determined such that human intervention is not required.

While adjustment of particle generation has been discussed thus far in terms of changes to the power supplied to the particle generator, e.g., on/off, increase/decrease, etc., changes to the particle generation may be accomplished by mechanisms other than changes in power output. For example, particle output may be modified by controlling fluid flow rate, nebulization rate, pressure, duty cycle, valve position, or aerosolization parameters, or by mechanical, pneumatic, thermal, electrostatic, or fluidic modulation techniques, independent of or in combination with electrical power modulation. Such alternative control methods permit precise regulation of particle concentration, size distribution, and emission timing, thereby providing enhanced flexibility and stability in aerosol generation.

A protocol of the present disclosure may be determined according to at least one interval, wherein the at least one interval is defined by a length of time or a timing sequence in which the method controls power to the particle generator. The at least one interval may include at least one timing sequence wherein the particle generator is turned on or power to the particle generator is increased to emit particles for a length of time and/or at least one timing sequence wherein the power to the particle generator is decreased or turned off for a length of time and particles are not emitted from the particle generator. Furthermore, the at least one interval may include at least one timing sequence wherein power is turned on or increased to emit particles immediately followed by at least one timing sequence wherein power is decreased or turned off to cease emitting particles, wherein these sequences are repeated at least once, resulting in pulsatile particle generation. The interval and/or timing sequence may correspond to the steps of a respirator fit test. As a non-limiting example, when the fit test subject is instructed to perform a step of a respirator fit test, a protocol may include instructions to initiate an interval having a first timing sequence to turn on or increase power to the particle generator to emit particles during the step of the respirator fit test. When the first timing sequence has elapsed, the protocol may include instructions to initiate a second timing sequence, decreasing or turning off power to the particle generator during the length of time of the second timing sequence.

As used herein, a time interval or timing sequence includes any length of time necessary to manage particle concentration. As a non-limiting example, the length of time for a time interval or timing sequence may include, but is not limited to, 10, 15, 20, 25, 30, 35, 40, 45, 50, 55, 60, 65, 70, 75, 80, 85, 90, 95, 100, 105, 110, 115, 120, 150, 180, 210, 240, 270, and 300 seconds. Multiple timing sequences within an interval may include the same length of time or may include different lengths of time. As a non-limiting example, power may be supplied to the particle generator for 30 seconds and then power may be turned off to the particle generator for 60 seconds.

A protocol of the present disclosure may include at least one interval according to the steps of the respirator fit test. Once a fit test subject, a fit test proctor, or a system for respirator fit testing has initiated a respirator fit test, the protocol may include particle generation instructions for the entire duration of the respirator fit test without a need for human input.

As a non-limiting example, a protocol may include a time interval wherein the particle generator is supplied power for the entire duration of a fit test to ensure a stable fit test environment. Power may be cycled to maintain the stable fit test environment with more or less particles according to the methods of the present disclosure.

A protocol of the present disclosure may include at least one interval pre-determined according to the size of the fit test environment, such as the size of the room. A protocol of the present disclosure may include at least one interval pre-determined according to the size of the breathing zone. The length of time power is supplied to the particle generator may be dependent upon the size of the fit test environment such as the size of the room or whether the fit test environment is an open space. As a non-limiting example, a larger room may require a longer length of time controlling power to the particle generator.

A protocol of the present disclosure may include at least one interval predetermined according to the size of the breathing zone of the fit test subject. A protocol of the present disclosure may include at least one interval pre-determined according to the distance from the fit test subject to the particle generator. The distance may include any distance sufficient to manage particle concentrations within the breathing zone. The size of the breathing zone may include at least a 10-inch radius around the respirator wearer’s nose and mouth. The size of the breathing zone may be at least 10, 12, 14, 16, 18, 20, 24, 28, 32, 36, 38, 40, or at least 48 inches. The size of the breathing zone may be not more than 48 inches, such as 48, 40, 38, 36, 32, 28, 24, 20, 18, 16, 14, 12, and 10 inches. Any combination of upper and lower limits are within the scope of the present disclosure, including, but not limited to, 10 inches to 12 inches, 10 inches to 24 inches, 10 inches to 36 inches, 10 inches to 48 inches, 12 inches to 24 inches, 12 inches to 36 inches, 24 inches to 48 inches, and the like. While a breathing zone of up to 48 inches is described herein, a larger breathing zone is possible and within the scope of the present disclosure.

A protocol of the present disclosure may include at least one interval pre-determined according to one or more of: the size of the fit test environment, the size of the breathing zone, the distance from the fit test subject to the particle generator, and/or the steps of the respirator fit test. As used herein, a step of a respirator fit test refers to any step of a respirator fit test known in the art, as defined by a particular fit testing device or as defined by codes/standards such as OSHA.

One or more intervals of controlling power to the particle generator during a respirator fit test maintains a target particle concentration in the fit test environment.

The method 100 may include emitting particles into the breathing zone before a respirator fit test is initiated in order to establish a target particle concentration in the breathing zone of the fit test subject. The target particle concentration may include the minimum particle concentration necessary to begin a respirator fit test. The method 100 may include emitting particles into the breathing zone during a respirator fit test to establish and/or maintain a target particle concentration in the breathing zone of the fit test subject. The method 100 may include emitting particles into the breathing zone after a respirator fit test to maintain the target particle concentration between respirator fit tests.

The methods of the present disclosure do not require human intervention. The methods of the present disclosure do not require human activation. The methods of the present disclosure control power to the particle generator in order to control particle concentration in the breathing zone without the need for human intervention. Manually cycling power to the particle generator is burdensome for a human fit test operator. Human senses, even with a handheld particle measurement device, are not able to accurately and/or efficiently control the power to effectively manage the particle concentration necessary to successfully conduct a respirator fit test. As a result, the inconsistent management of particle concentration may result in unnecessary failures of the respirator fit test or fit test device. Accordingly, the burdens imposed on human operators may incorrectly determine that a respirator does not properly fit and/or may cause the fit test device to not function properly. Conventional methods and particle generators that are overseen manually by an operator emit particles without regard to the condition of the environment, the respirator fit test, or the position of the fit test subject. Conventional methods and particle generators are prone to user error. Continuous operation of the particle generator or manually controlling the power to a particle generator may damage the fit test device and/or particle generator. Long term exposure or overexposure to particles may damage or clog machines such as the fit test device or particle generator within the fit test environment.

The methods of the present disclosure remove the one or more burdens from the human operator by efficiently and accurately managing particle concentration in the breathing zone of the fit test subject without the need for human intervention. The methods of the present disclosure address the one or more shortcomings of conventional methods and particle generators. The methods of the present disclosure are less prone to user error and/or protect the instruments from overexposure to particles and damage.

Optionally, the length of tubing connecting the respirator to the fit testing may determine the size of the breathing zone, and the methods and systems of the present disclosure may improve upon the prior art by accommodating for different lengths of tubing or changes in the breathing zone. Ambient or already existing particle concentrations may rise or fall to levels that are not desirable or necessary for proper respirator fit tests. This may cause an inaccurate or inconsistent respirator fit test or may cause issues with the fit testing device. Increased particle concentrations may stress the fit test device and/or cause clogging in the fit test device. Damage or clogging in the fit test device causes unnecessary repairs. Decreased or too low particle concentrations may cause false failures of a respirator fit test, further increasing inefficiency and burdens on the fit test operator and fit test subject. Decreased particle concentrations may cause a respirator to incorrectly determine a properly fitting respirator is in fact improperly fitting. Furthermore, human fit test proctors, human fit test subjects, and systems for respirator fit testing known in the art are unable to detect and effectively manage particle concentrations in the fit test environment or breathing zone, causing inconsistent or imprecise respirator fit tests and/or resulting in incorrect respirator fitting determinations, such as incorrectly determining whether the respirator fits or does not fit. The present disclosure provides methods and systems to efficiently and accurately manage particle concentrations before, during, and after a respirator fit test without the need for human intervention, including particle concentrations undetectable and not addressable by a human.

The methods and systems of the present disclosure address one or more of the shortcomings discussed above by providing more efficient and accurate particle generation management that is easier and simpler to administer without the need for human intervention. The methods and systems of the present disclosure are also less dependent, or not dependent, upon the size of the room or open space for the fit test environment. Properly managing the particles reduces repair expenses and creates a longer lifespan for the fit testing device between preventative maintenance operations.

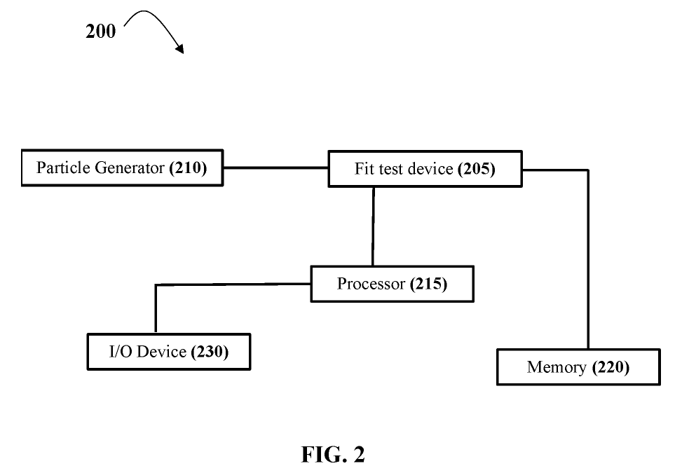

FIG. 2 is a block diagram that schematically illustrates a system 200 according to the present disclosure. The system 200 may comprise a processor 215 that interfaces with memory 220 (which may be separate from or included as part of processor 215). The memory 220 may also employ cloud-based memory. In one aspect, the system may connect to a base station that includes memory and processing capabilities. The system may further comprise an I/O device 230.

The present disclosure provides systems for managing particle concentrations before, during, and after a respirator fit test. Memory 220 has stored therein a number of routines that are executable by processor 215. The processor 215, in communication with the memory 220, may be configured to execute a particle management protocol.

The particle management protocol executed by the processor 215, in communication with the memory 220, may be any respirator fit test protocol that utilizes the measurement of particles, including, but not limited to, condensation nuclei counting.

The present disclosure provides a system for managing particle concentrations before, during, and after a respirator test, a processor separate from the fit test device 205 or a processor of the fit test device, a memory separate from the fit test device 205 or a memory of the fit test device 205, the memory storing computer-readable instructions that, when executed by the processor, cause the processor to trigger execution of a particle management protocol, wherein the particle management protocol includes program instructions to perform the methods described herein, including, but not limited to: control power to a particle generator 210 to establish a target particle concentration in a breathing zone of a respirator fit test subject as described herein; collecting particle concentration data as described herein; analyze the particle concentration data as described herein; and control, in real time without need for human intervention, power to the particle generator to maintain the target particle concentration.

The present disclosure provides a system for managing particle concentrations before, during, and after a respirator test, a processor separate from the fit test device 205 or a processor of the fit test device, a memory separate from the fit test device 205 or a memory of the fit test device 205, the memory storing computer-readable instructions that, when executed by the processor, cause the processor to trigger execution of a particle management protocol, wherein the particle management protocol includes program instructions to perform the methods described herein, including, but not limited to: control power to a particle generator 210 to establish a target particle concentration in a breathing zone of a respirator fit test subject as described herein; collect particle concentration data as described herein; analyze the particle concentration data as described herein, including comprising comparing the particle concentration data to the target particle concentration; and emitting at least one particle from a particle generator into the breathing zone according to a protocol comprising at least one interval as described herein.

The particle management protocol may include any program instructions according to the methods of the present disclosure described herein.

While the system 200 of the present disclosure may include a system that is separate from the fit test device, the methods, computer program instructions, and/or particle management protocol may be implemented using the system of the fit test device itself, wherein the fit test device includes computer program instructions to conduct a respirator fit test and conduct the methods of the present disclosure.

The systems of the present disclosure may further include a database. The database may include target particle concentration data or historical particle concentration data for a fit test protocol, a previous fit test step, a fit test environment, or a specific fit test individual. The system may include program instructions to access the database. The system may include program instructions to compare the target particle concentration data or historical particle concentration data to compare to the collected particle concentration data.

The present disclosure also provides for a computer program product for managing particle concentrations before, during, and after a respirator test, including at least one non-transitory computer readable medium, including program instructions that, when executed by at least one processor, cause the at least one processor to: control power to a particle generator 210 to establish a target particle concentration in a breathing zone of a respirator fit test subject as described herein; collecting particle concentration data as described herein; analyze the particle concentration data as described herein; and control, in real time without need for human intervention, power to the particle generator to maintain the target particle concentration.

The present disclosure also provides for a computer program product for managing particle concentrations before, during, and after a respirator fit test, including at least one non-transitory computer readable medium, including program instructions that, when executed by at least one processor, cause the at least one processor to: control power to a particle generator 210 to establish a target particle concentration in a breathing zone of a respirator fit test subject as described herein; collect particle concentration data as described herein; analyze the particle concentration data as described herein, including comprising comparing the particle concentration data to the target particle concentration; and emitting at least one particle from a particle generator into the breathing zone according to a protocol comprising at least one interval as described herein.

The computer program product of the present disclosure may manage particle concentrations according to the methods and systems described herein.

Processor 215 may be one or more microprocessors, microcontroller, an application specific integrated circuit (ASIC), a circuit containing one or more processing components, a group of distributed processing components, circuitry for supporting a microprocessor, or other suitable processing device that interfaces with memory 220. Processor 215 is also configured to execute computer code stored in memory 220 to complete and facilitate the activities described herein.

I/O device 230 (including, but not limited to, keyboards, displays, pointing devices, DASD, tape, CDs, DVDs, thumb drives, and other memory media, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards may be just a few of the available types of network adapters.

As will be appreciated by one skilled in the art, the present disclosure may be embodied as a system, method, or computer program product. Accordingly, the present disclosure may take the form of an entirely hardware aspect, an entirely software aspect (including firmware, resident software, micro-code, etc.), or an aspect combining software and hardware aspects that may all generally be referred to herein as a “system.” Furthermore, the present disclosure may take the form of a computer program product embodied in any tangible medium of expression having computer useable program code embodied in the medium.

The present disclosure may include a kit having one or more of: a particle generator, a respirator fit test device, a cable configured to provide electrical connection/communication between the particle generator and the fit test device, a computer program product capable of managing particle concentrations before, during, and/or after a respirator test, at least one adapter, at least one probe, at least one tubing, at least one respirator, or any combination thereof.

The present disclosure may include a kit having a particle generator, a computer program product capable of managing particle concentrations before, during, and after a respirator test, and a cable configured to provide electrical connection/communication between the particle generator and the fit test device.

The present disclosure may include a kit having a computer program product capable of managing particle concentrations before, during, and after a respirator test, and a cable configured to provide electrical connection/communication between a particle generator and a fit test device.

The present disclosure may include a kit having a respirator fit test device that includes an integrated particle generator and a computer program product capable of managing particle concentrations before, during, and after a respirator test.

Any combination of one or more computer useable or computer readable medium(s) may be utilized. The computer-useable or computer-readable medium may be, for example but not limited to, an electronic, magnetic, optical, electromagnetic, infrared, or semiconductor system, apparatus, device, or propagation medium. Computer-readable medium may also be an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, a magnetic storage device, a digital versatile disk (DVD), a memory stick, a floppy disk, a mechanically encoded device such as punch-cards or raised structures in a groove having instructions recorded thereon, and any suitable combination of the foregoing. Note that the computer-useable or computer-readable medium may be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-useable or computer-readable medium may be any medium that can contain, store, communicate, propagate, or transport the program for use by or in connection with the instruction execution system, apparatus, or device. The computer-useable program code may be transmitted using any appropriate medium, including but not limited to wireless, wireline, optical fiber cable, RF, etc.

Computer program code for carrying out operations of the presently disclosed invention may be written in any combination of one or more programming languages. The programming language may be, but is not limited to, object-oriented programming languages (Java, Smalltalk, C++, etc.) or conventional procedural programming languages (“C” programming language, etc.). The program code may execute entirely on a user's computer, partly on the user's computer, as a stand-alone software package, partly on a user's computer and partly on a remote computer, or entirely on the remote computer or server. In the latter scenario, the remote computer may be connected to the user's computer through any type of network, including a local area network (LAN) or a wide area network (WAN), or the connection may be made to an external computer, which may include through the Internet using an Internet Services Provider. In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The systems and methods of the present disclosure may process data on any commercially available computer. In other aspects, a computer operating system may include, but is not limited to, Linux, Windows, UNIX, Android, or MAC OS. In one aspect of the present disclosure, the foregoing processing devices or any other electronic, computation platform of a type designed for electronic processing of digital data as herein disclosed may be used.

Aspects of the present disclosure are described with reference to flowchart illustrations and/or block diagrams of methods, systems, and computer program products according to aspects of the present disclosure. It will be understood that each block of the flowchart illustrations and/or block diagrams, and combination of blocks in the flowchart illustrations and/or block diagrams, may be implemented by computer program instructions. These computer program instructions may be provided to a processor of a general-purpose computer, special purpose computer, or other programmable data processing apparatus to produce a machine, which the instructions execute via the processor of the computer or other programmable data processing apparatus allowing for the implementation of the steps specified in the flowchart and/or block diagram blocks or blocks.

Various aspects of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code to reduce the number of times code must be retrieved from bulk storage during execution.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, among others.

It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by this disclosure. Further, any features, aspects, and advantages that may be present in the prior art may be affirmatively disclaimed. Accordingly, this disclosure may comprise, consist of, consist essentially of, or be characterized by one or more of the features, aspects, and advantages described herein.

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in the context of this specification and should not be interpreted in an idealized or overly formal sense unless expressly so defined herein.

As used herein, the term “Condensation Nuclei Counting” or “condensation nuclei counter” or “CNC” or “ambient aerosol” or “ambient aerosol condensation nuclei counter” refers to a quantitative fit testing method utilizing laser technology to measure aerosol leakage into a respirator with aerosols in the ambient air as the test challenge agent. CNC may comprise a probe on the respirator capable of sampling the air from inside the mask. Test challenging agents include but are not limited to, ambient air or sodium chloride.

As used herein, the term “adapter” may be used to refer to any device capable of attaching and/or connecting a respirator to a fit testing device.

As used herein, the term “particle generator” refers to any device capable of controllably releasing particles into a fit test environment.

As used herein, the term “respirator” refers to, but is not limited to, a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, or a combination respirator.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean any of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” particle may include one or more particles, and the like.

The terms “comprises,” “comprising,” “including,” “having,” and “characterized by,” may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given aspect reciting compositions, materials, components, elements, features, integers, operations, and/or process steps, described herein also specifically includes aspects consisting of, or consisting essentially of, such recited compositions, materials, components, elements, features, integers, operations, and/or process steps. In the case of “consisting of,” the alternative aspect excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an aspect, but any compositions, materials, components, elements, features, integers, operations, and/or process steps that do not materially affect the basic and novel characteristics may be included in the aspect.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example aspects may be combined in or with various other example aspects in any permutational or combinatory manner. Different aspects or elements of example aspects, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Words such as “then,” “next,” etc., are not intended to limit the order of the steps; these words may be simply used to guide the reader through the description of the methods.

In the description, certain details are set forth to provide a better understanding of various aspects of the systems and methods disclosed herein. However, one skilled in the art will understand that these aspects may be practiced without these details and/or in the absence of any details not described herein. In other instances, well-known structures, methods, and/or techniques associated with methods of practicing the various aspects may not be shown or described in detail to avoid unnecessarily obscuring descriptions of other details of the various aspects.

While specific aspects of the disclosure have been provided hereinabove, the disclosure may, however, be embodied in many different forms and should not be construed as necessarily being limited to only the aspects disclosed herein. Rather, these aspects may be provided so that this disclosure is thorough and complete, and fully conveys various concepts of this disclosure to skilled artisans.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

All numerical quantities stated herein may be approximate, unless stated otherwise. Accordingly, the term “about” may be inferred when not expressly stated. The numerical quantities disclosed herein may be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example aspects may be combined and sub-combined in and/or with various other example aspects. Also, different aspects and/or elements of example aspects, as disclosed herein, may be combined and sub-combined in a similar manner as well. Further, some example aspects, whether individually and/or collectively, may be components of a larger system, wherein other procedures may take precedence over and/or otherwise modify their application. Additionally, a number of steps may be required before, after, and/or concurrently with example aspects, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application, including the appended claims, is therefore intended to cover all such changes and modifications that may be within the scope of this application.

### Examples

### Respirator fit testing

The present inventors have discovered the optimal intervals for activation/deactivation of the particle generator before, during, and after a fit test based on a wide range of factors that include any of a size of the fit test environment, position of the particle generator from the subject, room size, and the like. These intervals are combined in the novel protocol disclosed herein that automates activation of the particle generator before, during, and/or after a respirator fit test.

Respirator fit tests are evaluated for CNC systems using the methods of the present disclosure and compared to methods of the prior art. More specifically, a particle generator is connected to a fit test device using a cable as disclosed herein, and a fit test is performed according to standard procedure, wherein the particle generator is operated according to a protocol of the present disclosure (Inventive). This is compared to a particle generator operated manually during a fit test (comparative) and a particle generator separate from the fit test device.

Conventional particle generation occurs at undetermined distances that may lead to inconsistencies in the particle concentration in the fit test environment. The present disclosure limits the position of the particle generator to facing the breathing zone of the fit test subject to perform the methods of the present disclosure, which manage particle concentrations to create an optimal fit test environment. The consistency provided by the methods of the present disclosure leads to decreased variation in test concentrations, ensuring a proper challenge of the respirator during the fit test.

Data to collect includes pre, post, and in-test particle concentrations to determine the variation in particle concentration throughout the test. The present disclosure demonstrates increased consistency and uniformity compared to conventional methods, ensuring the challenge concentration of particles adequately challenges the respirator seals for the entirety of the fit test. Additional testing is completed at various distances with conventional methods compared to the methods of the present disclosure using known statistical analysis tools and indicators.

What is claimed is:

1. A computer-implemented and software-controlled method to manage particle concentrations, the method comprising:
controlling power to a particle generator to establish a target particle concentration in a breathing zone of a respirator fit test subject, wherein the breathing zone is within a respirator fit test environment, wherein a particle generator emits at least one particle, and wherein the particle generator is communicatively coupled with a respirator fit testing device;
collecting particle concentration data, wherein the particle concentration data comprises a particle concentration measured in the respirator fit test environment;
analyzing the particle concentration data, comprising comparing the particle concentration data to the target particle concentration; and
controlling, in real time without need for human intervention, power to the particle generator to maintain the target particle concentration.

2. The method of claim 1, wherein the target particle concentration comprises a range of particle concentrations.

3. The method of claim 1, wherein controlling, in real time without need for human intervention, power to the particle generator comprises increasing power to the particle generator.

4. The method of claim 1, wherein controlling, in real time without need for human intervention, power to the particle generator comprises decreasing power to the particle generator.

5. The method of claim 1, wherein controlling, in real time without need for human intervention, power to the particle generator comprises turning off power to the particle generator.

6. The method of claim 1, wherein controlling, in real time without need for human intervention, power to the particle generator comprises turning on power to the particle generator.

7. The method of claim 1, wherein controlling, in real time without need for human intervention, power to the particle generator comprises supplying power to the particle generator in pulses.

8. The method of claim 1, wherein controlling power to the particle generator to establish the target particle concentration in the breathing zone of the respirator fit test subject occurs prior to a respirator fit test.

9. The method of claim 1, wherein the particle generator maintains the target particle concentration when the respirator fit test is not occurring.

10. The method of claim 1, wherein the particle generator is wired to the respirator fit test device.

11. The method of claim 1, wherein the particle generator communicates wirelessly with the respirator fit test device.

12. The method of claim 1, wherein the particle generator is contained at least partially within the housing of the respirator fit test device.

13. A system for managing particle concentrations, the system comprising: a processor; and a memory storing computer-readable instructions that, when executed by the processor, cause the processor to trigger execution of the methods of claim 1.

14. A computer program product for managing particle concentrations, comprising at least one non-transitory computer readable medium including program instruction that, when executed by at least one processor, cause the at least one processor to perform the methods of claim 1.

15. A computer-implemented and software-controlled method to manage particle concentrations, the method comprising:
controlling power to a particle generator to establish a target particle concentration in a breathing zone of a respirator fit test subject, wherein the breathing zone is within a respirator fit test environment, wherein a particle generator emits at least one particle, and wherein the particle generator is in electrical communication with a respirator fit testing device;
collecting particle concentration data, wherein the particle concentration data comprises a particle concentration measured in the respirator fit test environment;
analyzing the particle concentration data, comprising comparing the particle concentration data to the target particle concentration; and
emitting at least one particle from a particle generator into the breathing zone according to a protocol comprisingat least one interval, wherein power to the particle generator is controlled during the at least one interval, wherein the at least one interval maintains the target particle concentration during a respirator fit test in real time, without the need for human intervention.

16. The method of claim 15, wherein the at least one interval is pre-determined according to at least one parameter of the respirator fit test.

17. The method of claim 15, wherein the at least one interval is pre-determined according to a size of the fit test environment.

18. A kit, comprising:
a particle generator;
a respirator fit test device;
a cable configured to provide electrical communication from the particle generator to the respirator fit test device; and
a computer-readable medium comprising program instructions that, when executed by at least one processor, cause the at least one processor to:
control power to a particle generator to establish a target particle concentration in a breathing zone of a respirator fit test subject, wherein the breathing zone is within a respirator fit test environment, wherein a particle generator emits at least one particle, and wherein the particle generator is in electrical communication with a respirator fit testing device;
collect particle concentration data, wherein the particle concentration data comprises a particle concentration measured in the respirator fit test environment;
analyze the particle concentration data, comprising comparing the particle concentration data to the target particle concentration; and
control, in real time without need for human intervention, power to the particle generator to maintain the target particle concentration.

19. The kit of claim 18, further comprising one or more of: an adapter, at least one tubing, and at least one respirator.
